(19) United States
(12) Patent Application Publication
(10) Pub. No.: US 2016/0139739 A1
(43) Pub. Date: May 19, 2016

(54) Simplified User Interface for the Elderly and the Vision Impaired

(71) Applicant: Stan Ciepcielinski, Charlotte, NC (US)

(72) Inventor: Stan Ciepcielinski, Charlotte, NC (US)

(21) Appl. No.: 14/542,563

(22) Filed: Nov. 15, 2014

(51) Int. Cl. G06F 3/0482; H04L 29/08; G06F 3/0484

(52) U.S. Cl. CPC G06F 3/0482; G06F 3/04842; H04L 67/02

(57) ABSTRACT

The present invention relates to user interfaces for smartphones and tablet computers generally. Particularly, the invention relates to user interfaces for smartphones and tablet computers optimized for use by the elderly and the vision impaired.

### CROSS-REFERENCE TO RELATED APPLICATIONS

This application takes benefit of U.S. Prov. App. No. 61/910899 filed Dec. 2, 2013 and hereby incorporates it in its entirety by reference.

### FIELD OF THE INVENTION

The present invention relates to user interfaces for smartphones and tablet computers generally. Particularly, the invention relates to user interfaces for smartphones and tablet computers optimized for use by the elderly and the vision impaired.

### BACKGROUND OF THE INVENTION

The elderly and the vision impaired have a need to use smartphones and tablet computers as pressing as their younger peers. These devices are an integral part of daily life for people of all ages. Indeed, they have become a primary human tool for the maintenance of human contact and socialization in Western societies. As a result, if denied effective access to these devices by means of diminishing visual of cognitive ability, seniors and the vision impaired run a risk of psychological isolation and personal isolation.

The dawn of the century brought near ubiquity in terms of cell phone usage; tablet computers became nearly ubiquitous a decade later. As a result, today's seniors and vision impaired individuals were pre-seniors and their normally sighted peers. As a result of the last decade they became consistent users of smartphones and tablet computers, weaving them as they did into the fabric of their personal lives. As these individuals began to age, and the inevitable age-related impairment of sensory and cognitive systems began, these individuals have become increasingly less comfortable with the devices that had become integral to their lives.

While cell phone and smartphone products like the Jitterbug® have been directed at this growing group of seniors and the vision impaired, these products jettison much of the functionality this new cadre of seniors and vision impaired individuals became familiar within the preceding decade. Simply put, today's smartphones designed for seniors and the vision impaired are too simple for today's savvy seniors and vision impaired individuals. Other products have deployed user interface elements that seek to accentuate the recognition of displayed information by means of tactile or audible feedback or by increasing the size of the displayed elements. This by itself is a useful, but incomplete solution.

What is needed therefore, is a user interface for smartphones and tablet computers that retains the broad functionality of today's mainstream smartphones and tablet computers, but is designed to interact with seniors and visually impaired users in visually and operationally more recognizable, obvious, and consistent ways.

### SUMMARY OF THE INVENTION

The present invention is a user interface for smartphones and tablet computers that: 1) Generally increases the size of the visual elements with which the user interacts to a range of sizes that they are recognizable by both senior citizens and those vision impaired individuals with the less-dire visual impairments commonly associated with advancing age; 2) Limits and regularizes the number of interface elements displayed by the user interface at any one time; and, 3) Standardizes the location and position of the user interface elements both at the level of the operating system and at the level of the individual applications, so that the user interface presented by the operating system and the user interfaces presented by each application are all visually similar, thus requiring no conscious effort to scan varying arrangements of displayed user interface elements to determine where the functional elements are. While the applications offered by the device run the full gamut of applications offered by today's smartphones and tablet computers, the user interfaces associated with these applications are systematically simplified in terms of user interface function and interactivity, so that seniors and the vision impaired will feel more comfortable with the device and thus use the device, and applications, more extensively. These simplified, standardized user interfaces not only heighten recognizability, but they also heighten usability, because the consistency offered by the various user interfaces causes the operating system and applications to seem less complex from an operational point of view. Such a simplified interface may be implemented so that it merely provides an alternative to the user interface found on the device (e.g. the Android user interface) or completely supplants the installed user interface.

It is thus a first object of the present invention to provide a user interface that allows access to the broad functionality presented by today's mainstream smartphones and tablet computers, but optimized to present that interaction to seniors and the visually impaired in more obvious, more readily perceptible, and utterly consistent ways.

It is a second object of the present invention to provide a series of commonly used applications, including but not limited to: email, calendar, camera, media players, a picture viewer, and an Internet browser that present the broad functionality of today's mainstream applications as deployed on smartphones and tablet computers, but with user interfaces optimized to interact with seniors and the visually impaired in more obvious, more readily perceptible, and utterly consistent ways.

### BRIEF DESCRIPTION OF THE DRAWINGS

FIG. 1 is a schematic view of the home screen of the operating system user interface for use on a tablet computer.

FIG. 2a is a schematic view of a top level screen of an email application defaulted to a sub-level screen of an email application user interface for use on a tablet computer where the user can review a list of received emails.

FIG. 2b is a schematic view of a sub-level screen of an email application user interface for use on a tablet computer where the user can read an email.

FIG. 2c is a schematic view of a sub-level screen of an email application user interface for use on a tablet computer where the user can compose a new email.

FIG. 2d is a schematic view of a sub-sub-level screen of an email application user interface for use on a tablet computer where the user can view a contact list and create new contacts.

FIG. 3a is a schematic view of a top level screen of a calendar application user interface for use on a tablet computer.

FIG. 3b is a schematic view of a sub-level screen of a calendar application user interface for use on a tablet computer where the user can create a new birthday.

FIG. 3c is a schematic view of a sub-level screen of a calendar application user interface for use on a tablet computer where the user can create a new appointment.

FIG. 3d is a schematic view of a sub-level screen of a calendar application user interface for use on a tablet computer where the user can create a new anniversary.

FIG. 3e is a schematic view of a sub-level screen of a calendar application user interface for use on a tablet computer where the user can create a new reminder.

FIG. 3f is a schematic view of a sub-level screen of a calendar application user interface for use on a tablet computer where the user can view events associated with a particular day.

FIG. 4 is a schematic view of a top level screen of a camera application user interface for use on a tablet computer.

FIG. 5a is a schematic view of a top level screen of a media application browser user interface for use on a tablet computer.

FIG. 5b is a schematic view of a sub-level screen of a media player user interface for accessing music for use on a tablet computer.

FIG. 5c is a schematic view of a sub-level screen of a media player user interface for playing music on a tablet computer.

FIG. 6a is a schematic view of a top level screen of a photo viewer application user interface for accessing and manipulating photo albums on a tablet computer.

FIG. 6b is a schematic view of a sub-level screen of a photo viewer application user interface for reviewing and selecting a photo from a photo album on a tablet computer.

FIG. 6c is a schematic view of a sub-level screen of a photo viewer application user interface for viewing, deleting, sharing a photo in an album on a tablet computer.

FIG. 6d is a schematic view of a sub-level screen of a photo viewer application user interface for creating and populating a new photo album on a tablet computer.

FIG. 7a is a schematic view of a top level screen of an Internet browser application user interface for accessing Internet sites on a tablet computer.

FIG. 7b is a schematic view of a sub-level screen of an Internet browser application user interface for accessing Internet sites on a tablet computer showing a particular webpage.

FIG. 8 is a schematic view of a top level screen of a game application browser interface for use on a tablet computer.

FIG. 9 is a schematic view of a top level screen of an application browser user interface for use on a tablet computer.

FIG. 10 is a schematic view of a task bar for use on a tablet computer.

FIG. 11 is a schematic view of a status dashboard user interface for use on a tablet computer.

### DETAILED DESCRIPTION OF THE INVENTION

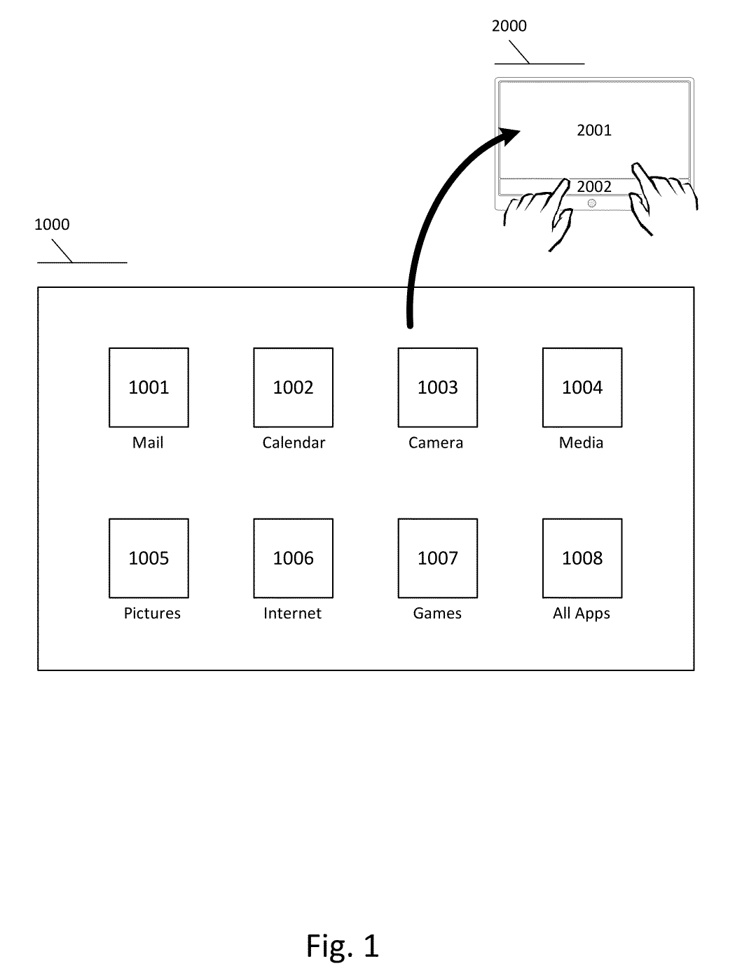

The present invention relates primarily to smartphones and tablet computers and is directed towards providing a user interface for such devices optimized for seniors and the visually impaired. FIG. 1 illustrates one such exemplary device 2000 (e.g. tablet computer 2000) implemented in accordance with the present invention which will be used to explain the various user interface features of the invention. It will be obvious that numerous variants of device 2000 are possible and all the features of device 2000 need not be included in all device embodiments. Also, while the exemplary implementation is a tablet computer 2000, it will be obvious that other such devices including but not limited to: smart phones, cell phones, personal computers, personal digital assistants, televisions, and so on, and that exemplary devices implemented in accordance with the present invention are designed with relatively few physical actuators, buttons, switches, or controls, as the bulk of interactivity is mediated by means of touch screen active areas or “soft buttons” and other virtual controls displayed on the screen of device 2000. Further, device 2000 may be provided with any one of a number of innate operating systems and user interfaces. For example, an Android® tablet or smartphone may be equipped with an Android operating system (e.g. Android 4.4 “KitKat”) featuring an Android user interface. Similarly, an Apple® iPad® may be equipped with an Apple operating system (e.g. iOS 7) featuring an Apple user interface. As such the present invention may be implemented so that it merely provides an alternative to the user interface innately found on the device (e.g. the Android user interface) or it completely supplants the installed user interface.

Like all top level program interfaces, home screen 1000 appears in zone 2001 on the display of tablet computer 2000. FIG. 1 shows a schematic view of home screen 1000 of a home screen user interface as it appears in area 2001. Home screen interface 1000 is comprised of eight touch screen active areas or soft buttons 1001 through 1008 ordered in two parallel rows of four soft buttons (1001 through 1004 and 1005 through 1008, respectively). Soft buttons 1001 through 1008 access the following functions, respectively: 1) Soft button 1001 accesses an email application; 2) Soft button 1002 accesses a calendar application; 3) Soft button 1003 accesses a camera application; 4) Soft button 1004 accesses a media application browser; 5) Soft button 1005 accesses a photo gallery application; 6) Soft button 1006 accesses an Internet browser; 7) Soft button 1007 accesses a game application browser; and, 8) Soft button 1008 accesses a global (all) application browser. The surface area occupied by soft buttons 1001 through 1008 constitutes at least 20% of home screen interface 1000 and no more than eight soft buttons are present on home screen 1000.

The user interacts with soft buttons 1001 through 1008 by touching the particular soft button with a finger or a stylus. When touched, each soft button on home screen 1000 transitions program flow from the operating system routine that displays home screen 1000 to a top level application preloaded in the non-volatile memory of tablet computer 2000. For example, if the user touches mail soft button 1001, an email program is activated. When the user touches Internet soft button 1006 a web browser is activated, and so on.

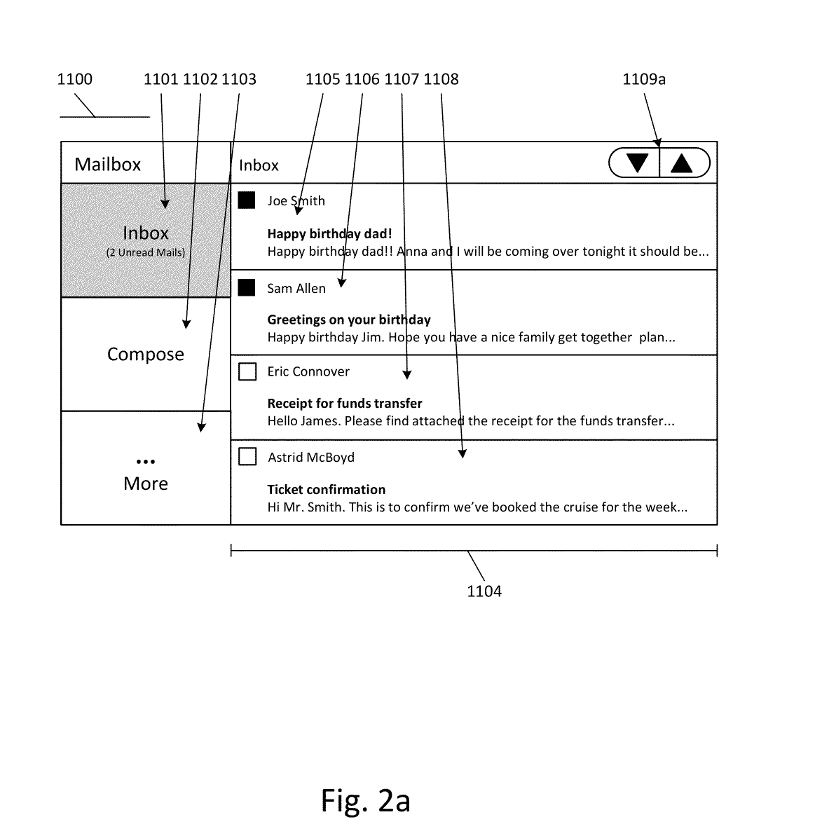

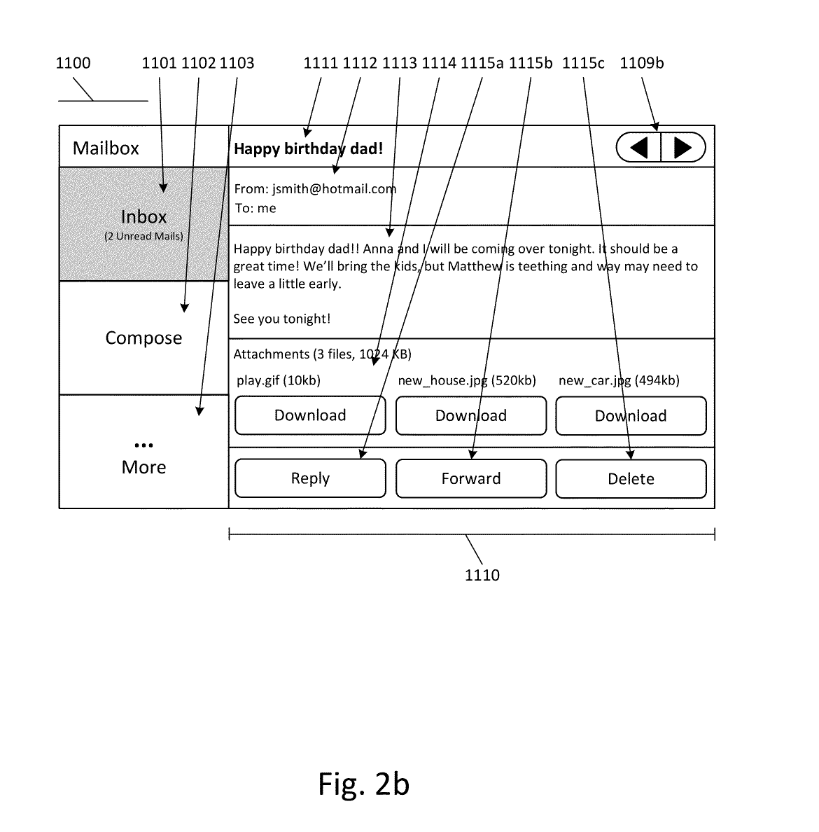

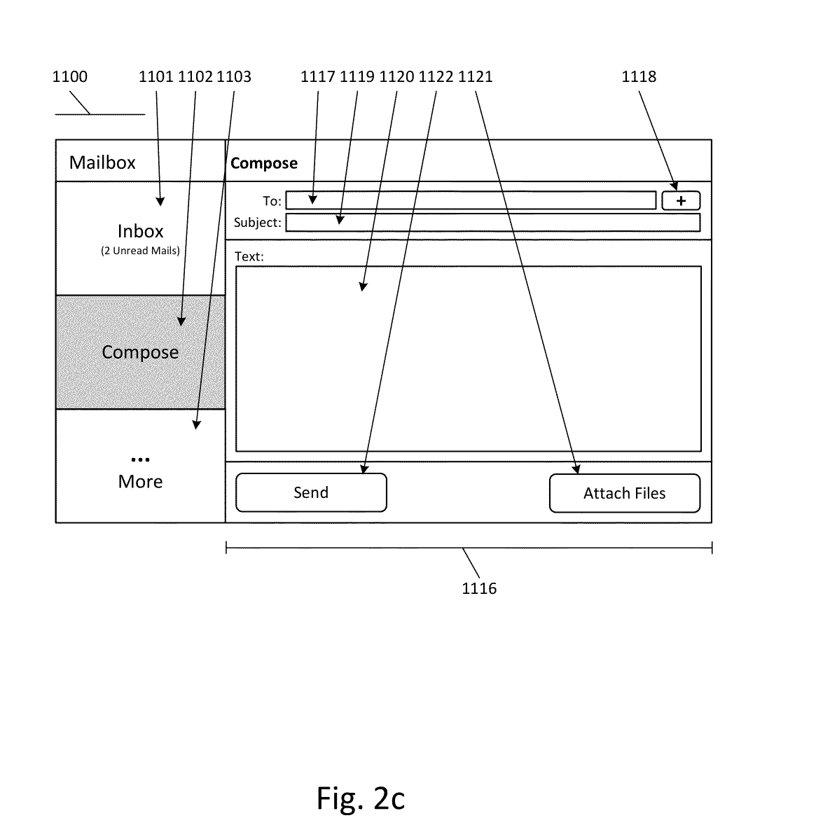

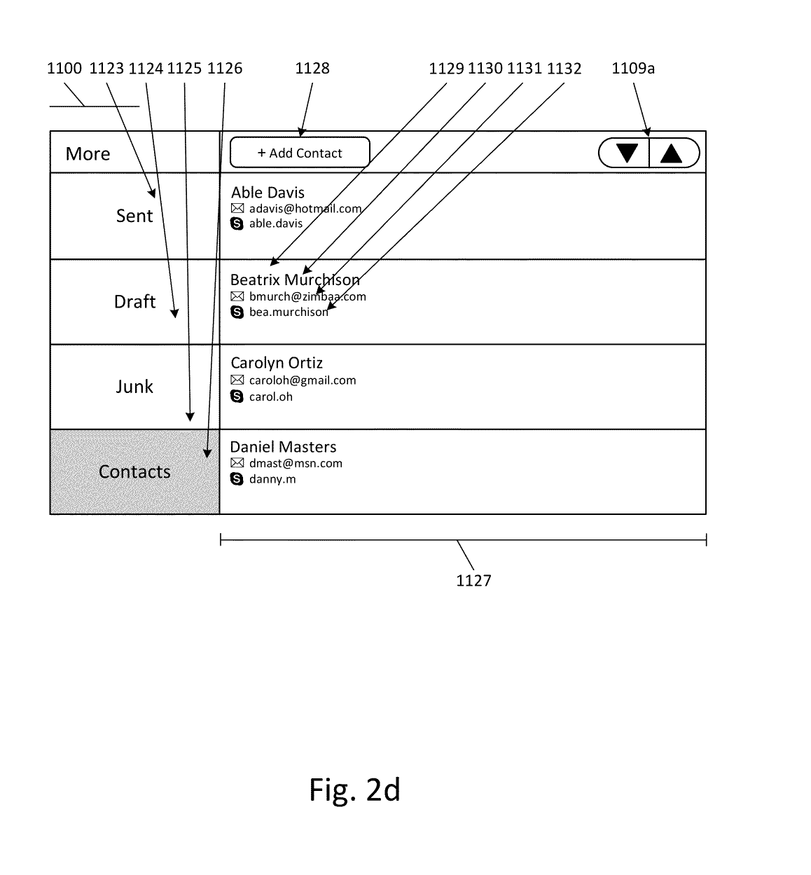

Referring now to FIGS. 1 and 2a though 2d, when the user touches mail soft button 1001, an email program is activated. The email program initially presents email top level user interface 1100. Email top level user interface 1100 has three soft buttons 1101 through 1103 arrayed on one side used, respectively, to activate: 1) The email sub-level inbox view as shown in FIG. 2a; 2) The email sub-level compose view as shown on FIG. 2c; and, 3) The email sub-level more options view as shown in FIG. 2d. The email program defaults to a state as if the user had touched inbox soft button 1101 and automatically presents email top level user interface 1100 preset to show the email sub-level inbox view as shown in FIG. 2a. Email list area 1104 is initially populated with the most recent email messages 1105 through 1108 received. Each email message in email list area 1104 presents, at a minimum, the sender, the subject, and the first line of the message. Unread email messages (e.g. 1105 and 1106) are marked with an annunciator, in this case a black checkbox, indicating that they have not been read. Similarly, read email messages (e.g. 1107 and 1108) are marked with an annunciator, in this case a white checkbox, indicating that they have been read. If more than page full of email messages are available for review, the user may touch and swipe email list area 1104 in a vertical motion to scroll to newer and/or older messages. Since such gestures are unfamiliar or difficult to execute for many seniors and visually impaired individuals, vertical scrolling soft button 1109a is provided. The left half of vertical scrolling soft button 1109a moves the list down (towards the most recent email) while the right half moves the list up (towards the oldest email). The surface area occupied by soft buttons 1101 through 1103 constitutes about at least 20% of email top level user interface 1100 and no more than three soft buttons are present on email top level user interface 1100. Also, the number of email message list records visible in email list area 1104 may never exceed five.

If the user touches an entry in email list area 1104 (e.g. email message 1105) the email sub-sub-level message view as shown in FIG. 2b is activated. Each email message in email message area 1110 includes, at a minimum, the subject 1111, from whom the email was sent and to whom it was addressed 1112, and the message 1113. Also, if attachments were transmitted with the email message, they appear in area 1114 where each may be downloaded by means of a separate download button. The user may reply to the email message, forward the email message, or delete the email message by touching soft buttons 1115a, 1115b, and 1115c, respectively. If more than one email message has been received, the user may touch and swipe email message area 1110 in a horizontal motion to scroll to newer and/or older messages. Since such gestures are unfamiliar or difficult to execute for many seniors and visually impaired individuals, horizontal scrolling soft button 1109b is provided. The left half of horizontal scrolling soft button 1109b loads the next newer email, if any, while the right loads the next older email, if any.

If the user touches compose soft button 1102, the email sub-level compose view as shown in FIG. 2c is activated. Each new, blank email message in email composition area 1116 includes addressee field 1117 for the email addresses of the individuals to whom the email message is directed and subject field 1119. Addressees are selected and added by means of the add addressee soft button 1118. The user enters the email text in message box 1120, and after concluding the message, attaches any files to be sent with the message using attach files soft button 1121 or simply sends the message using send message soft button 1122.

If the user touches more options soft button 1103 the more options sub-level view as shown in FIG. 2d is activated. Email top level user interface 1100 now has four soft buttons 1123 through 1126 arrayed on one side used, respectively, to activate: 1) The email sub-sub-level sent messages view; 2) The email sub-sub-level draft messages view; 3) The email sub-sub-level junk messages view; and, 4) The email sub-sub-level contacts view as shown in FIG. 2d. The email program defaults to a state as if the user had touched sent messages soft button 1123 and automatically presents email top level user interface 1100 preset to show the sent messages sub-sub-level list view. The surface area occupied by soft buttons 1123 through 1126 constitutes about at least 20% of email top level user interface 1100 in this mode and no more than four soft buttons are present on email top level user interface 1100 are present in this mode.

If the user touches contacts soft button 1126 contacts list area 1127 is activated. Contacts list area 1127 is initially populated with previously entered contact records. Each contact record (e.g. 1129) in contacts list area 1127 includes at a minimum the contact's name 1130 and the contact's email address 1131. Other contact specific information such as the contact's social media id 1132, for example, may be included. Add contact soft button 1128 is included to allow the user to add additional contacts to the contact list. If sufficient contacts have been entered to exceed the number that may be displayed in contacts list area 1127, the user may touch and swipe contacts list area 1127 in a vertical motion to scroll to different contacts. Since such gestures are unfamiliar to, or difficult to execute for, many seniors and visually impaired individuals, vertical scrolling soft button 1109a is provided. The left half of vertical scrolling soft button 1109a moves the contact list down (towards the contact alphabetized first) while the right half moves the contact list up (towards the contact alphabetized last). Further, the number of contact list records visible in contact list area 1127 may never exceed five.

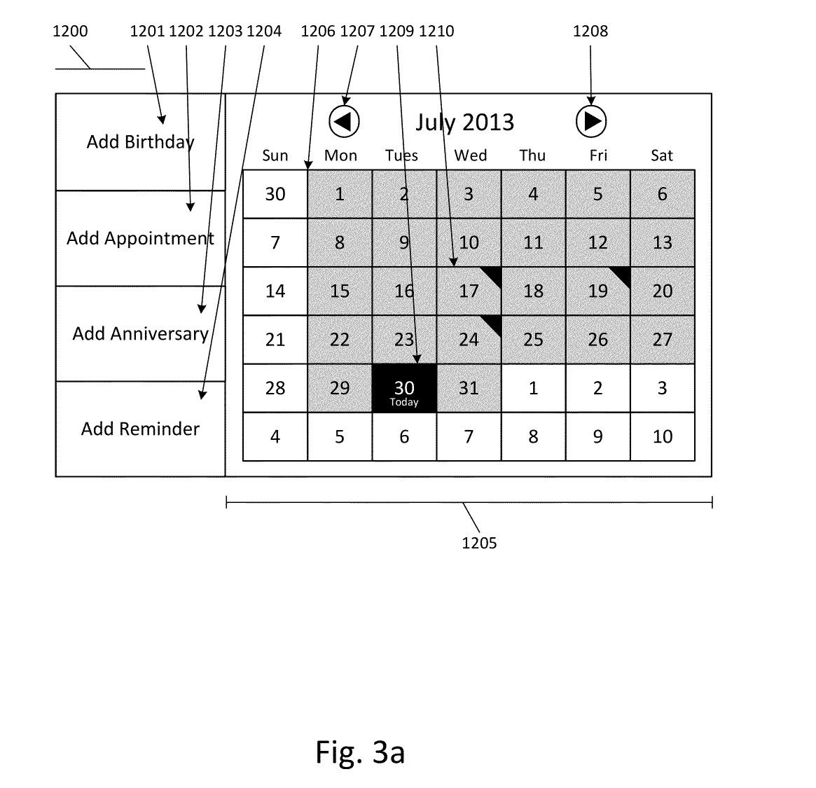

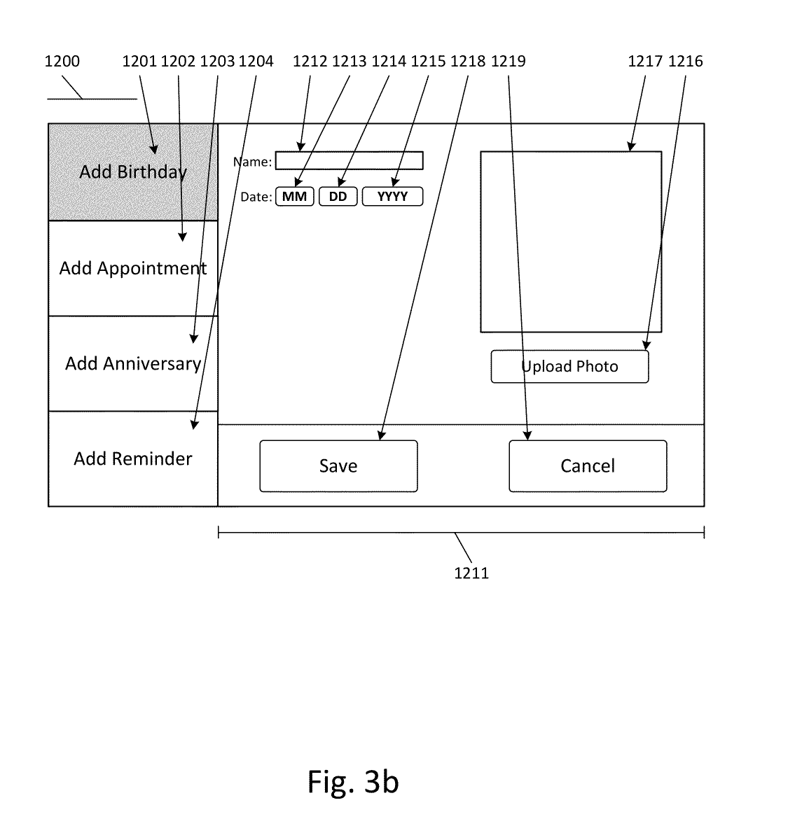

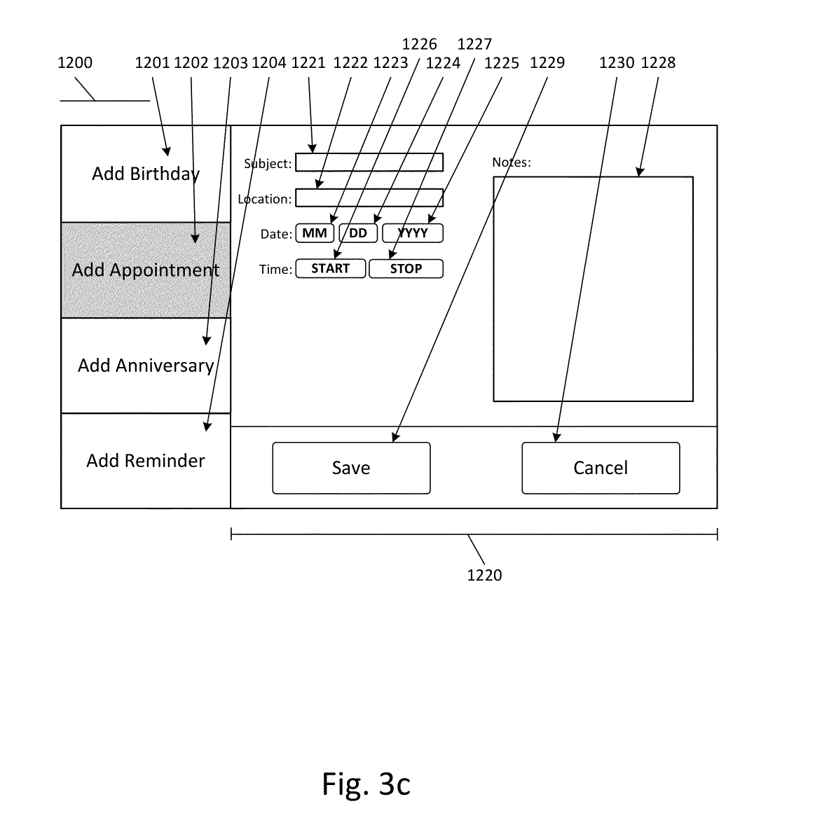

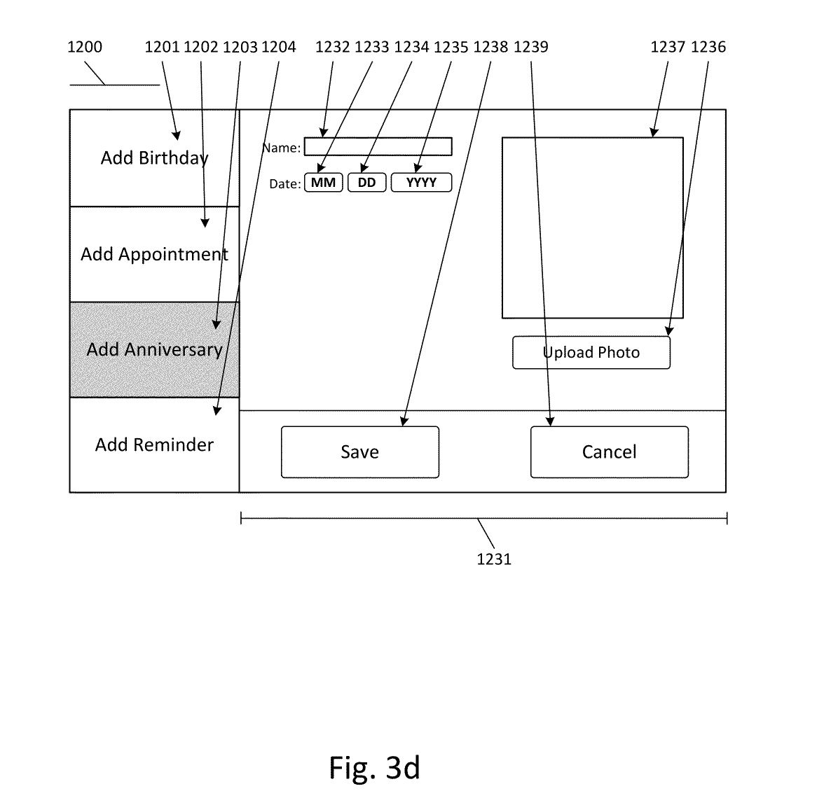

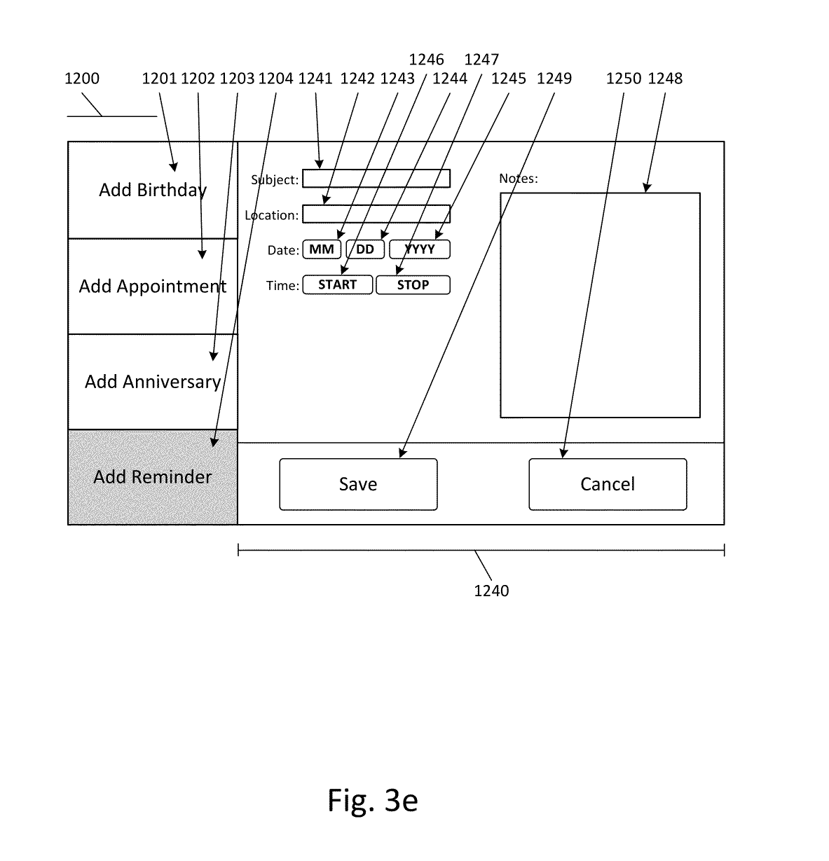

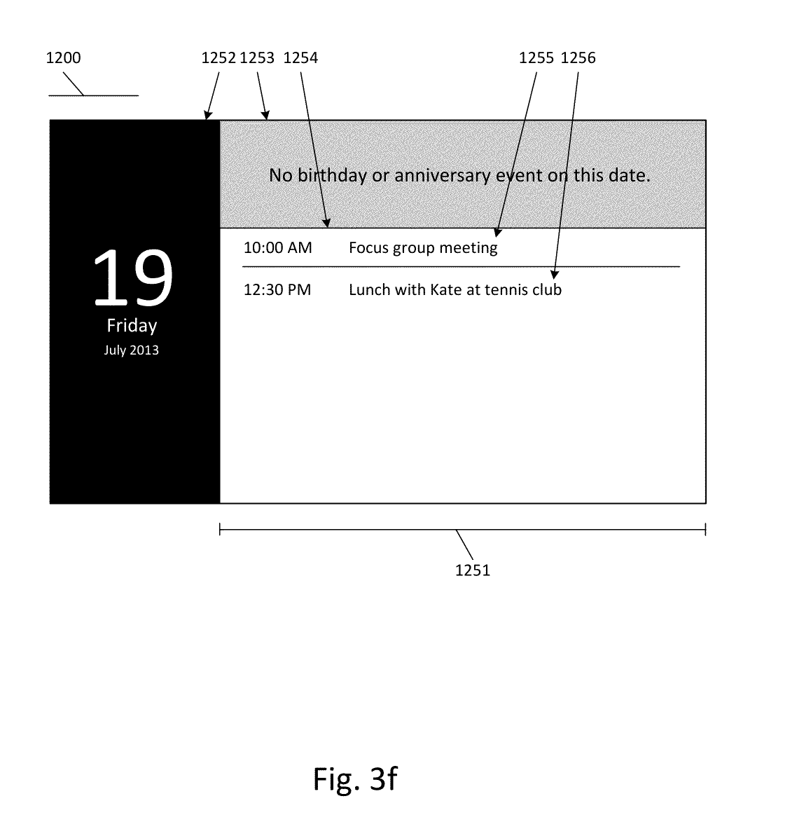

Referring now to FIGS. 1 and 3a though 3e, when the user touches calendar soft button 1002, a calendar program is activated. The calendar program initially presents calendar top level user interface 1200. Calendar top level user interface 1200 has four soft buttons 1201 through 1204 arrayed on one side used, respectively, to activate: 1) The calendar sub-level add birthday view as shown in FIG. 3b; 2) The calendar sub-level add appointment view as shown on FIG. 3c; 3) The calendar sub-level add anniversary view as shown in FIG. 3d; and, 4) The calendar sub-level add reminder view as shown in FIG. 3e. When first activated the calendar program defaults calendar top level user interface 1200 to show the calendar top level view as shown in FIG. 3a. Calendar area 1205 is populated with a schematic view of calendar 1206 representing the current month. The current day 1209 is highlighted and textually identified as such. Days on which birthdays, appointments, anniversaries, and reminders occur (e.g. 1210) are marked with an annunciator to show that an event is scheduled to occur that day. The user may touch and swipe calendar area 1205 in a horizontal motion to scroll to view future or past months. Since such gestures are unfamiliar or difficult to execute for many seniors and visually impaired individuals, previous month horizontal scrolling soft button 1207 and next month horizontal scrolling button 1208 are provided. Previous month horizontal scrolling soft button 1207 displays the month prior to the month currently displayed in calendar area 1205 while next month horizontal scrolling soft button 1208 displays the month after the month presently displayed in calendar area 1205. The surface area occupied by soft buttons 1201 through 1204 constitutes about at least 20% of calendar top level user interface 1200 and no more than four soft buttons are present on calendar top level user interface 1200.

If the user touches add birthday soft button 1201, the calendar sub-level add birthday view as shown in FIG. 3b is activated. Each new, blank birthday in birthday details area 1211 includes name field 1212 for the celebrant's name, and separate month, day, and year soft buttons 1213, 1214, and 1215, respectively, to allow the user to specify the month, day, and year of the birthday. Upload photo soft button 1216 allows the user to select a photo from a photo already stored on the device to use as a reminder. The selected photo is displayed in photo area 1217. After entering the new birthday, the user touches save soft button 1218 to save the new birthday or cancel soft button 1219 to clear the new birthday just entered.

If the user touches add appointment soft button 1202, the calendar sub-level add appointment view as shown in FIG. 3c is activated. Each new, blank appointment in appointment details area 1220 includes subject field 1221 for the subject of the meeting, location field 1222 for the location of the meeting, separate month, day, and year soft buttons 1223, 1224, and 1225, respectively, to allow the user to specify the month, day, and year of the appointment; and separate start and stop soft buttons 1226 and 1227, respectively, to allow the user to designate a start time and a stop time for the appointment. The user may enter a brief textual note as a reminder in text box 1228. After entering the new appointment the user touches save soft button 1229 to save the new appointment or cancel soft button 1230 to clear the new appointment just entered.

If the user touches add anniversary soft button 1203, the calendar sub-level add anniversary view as shown in FIG. 3d is activated. Each new, blank anniversary in anniversary details area 1231 includes name field 1232 for the celebrant's name, and separate month, day, and year soft buttons 1233, 1234, and 1235, respectively, to allow the user to specify the month, day, and year of the anniversary. Upload photo soft button 1236 allows the user to select a photo from a photo already stored on the device to use as a reminder. The selected photo is displayed in photo area 1237. After entering the new anniversary, the user touches save soft button 1238 to save the new anniversary or cancel soft button 1239 to clear the new anniversary just entered.

If the user touches add reminder soft button 1204, the calendar sub-level add reminder view as shown in FIG. 3e is activated. Each new, blank reminder in reminder details area 1240 includes subject field 1241 for the subject of the reminder, location field 1242 for the location of the any activity associated with the reminder, separate month, day, and year soft buttons 1243, 1244, and 1245, respectively, to allow the user to specify the month, day, and year of the reminder; and separate start and stop soft buttons 1246 and 1247, respectively, to allow the user to designate a start time and a stop time for the reminder. The user may enter a brief textual note as a reminder in text box 1248. After entering the new reminder the user touches save soft button 1249 to save the new reminder or cancel soft button 1250 to clear the new reminder just entered.

If the user touches a day on calendar 1206 on which a birthday, appointment, anniversary, or reminder occurs (e.g. 1210), the calendar sub-level day view as shown in FIG. 3f is activated. The day selected and its month, year, and day in the week are displayed in date box 1252. Each day details area 1251 includes birthday/anniversary reminder list 1253 and appointment/reminder list 1254. Both birthday/anniversary reminder list 1253 and appointment/reminder list 1254 show a list birthday/anniversary events (if any) or appointment/reminder events (e.g. 1255 and 1256), respectively, for the selected day.

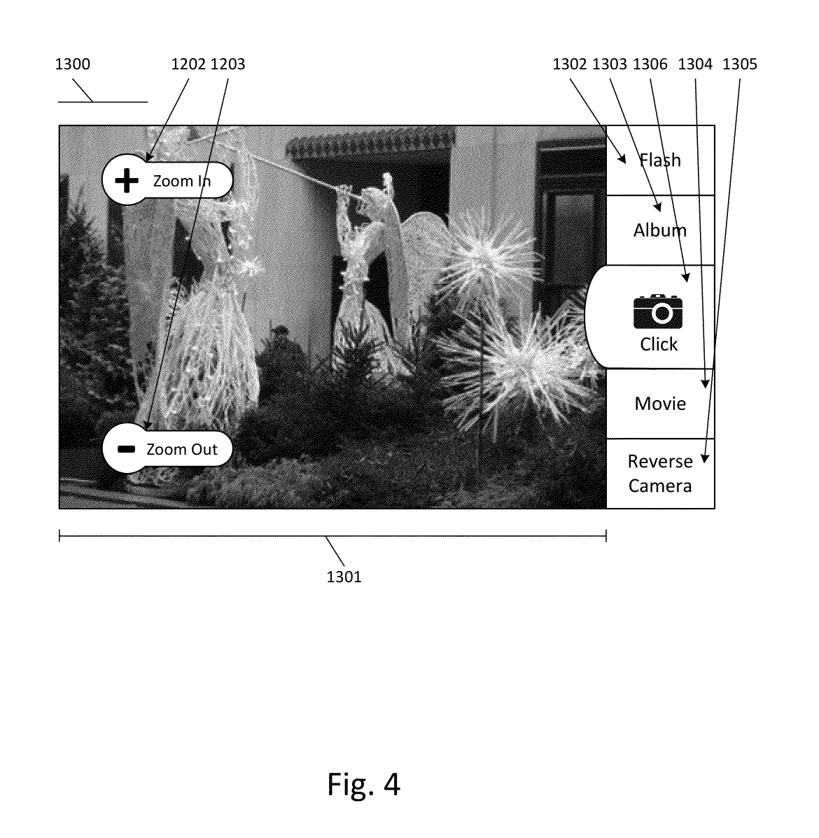

Referring now to FIGS. 1 and 4, when the user touches camera soft button 1003, a camera program is activated. The camera program initially presents camera top level user interface 1300. Camera top level user interface 1300 has five soft buttons 1302 through 1305 arrayed on one side used, respectively, to: 1) Toggle the flash on and off; 2) Select or create a photo album into which the new photos are stored; 3) Actuate the imaging system to take a photo; 4) Toggle movie/still image mode; and, 5) Toggle between back facing and front facing cameras. When activated, the calendar program displays camera top level user interface 1300 which shows the image to be captured in image area 1301. The user can zoom the composition in and out by means zoom in soft button 1202 and zoom out soft button 1203, respectively. To use the camera program, the user touches album soft button 1303 and optionally selects or creates a photo album into which the new photos will be placed. If no album is selected, the new photos are placed in the default camera album. Next, the user touches reverse camera soft button 1305 to select the front facing or rear facing camera. Next, the user touches movie soft button 1304 to select still photo mode or movie mode. Next, the user touches flash soft button 1302 to turn the flash on or off. Finally, the user touches camera soft button 1306 to take a still photo or begin recording a movie.

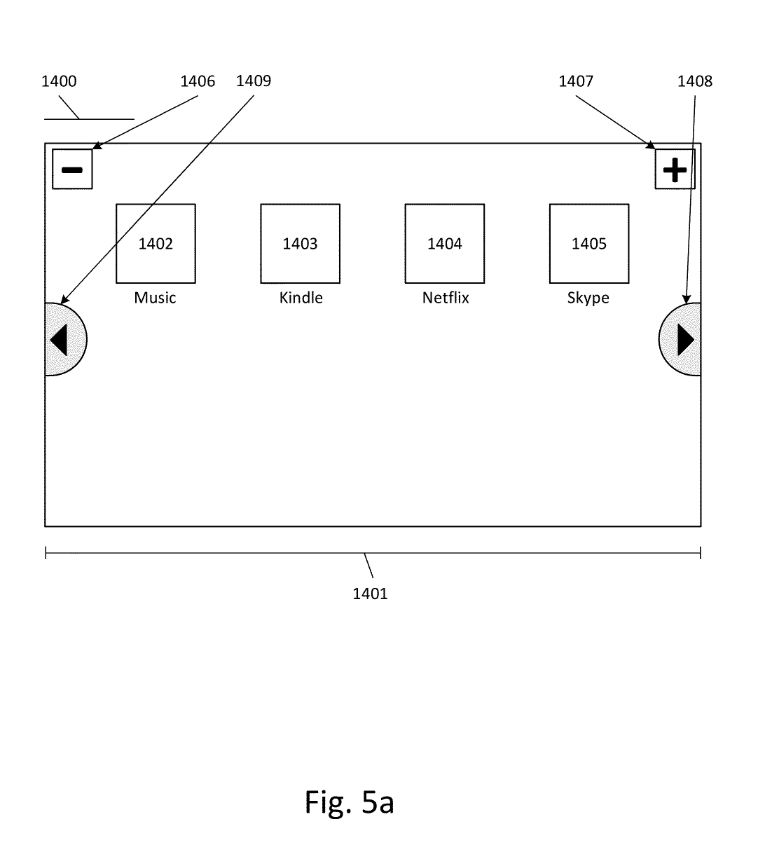

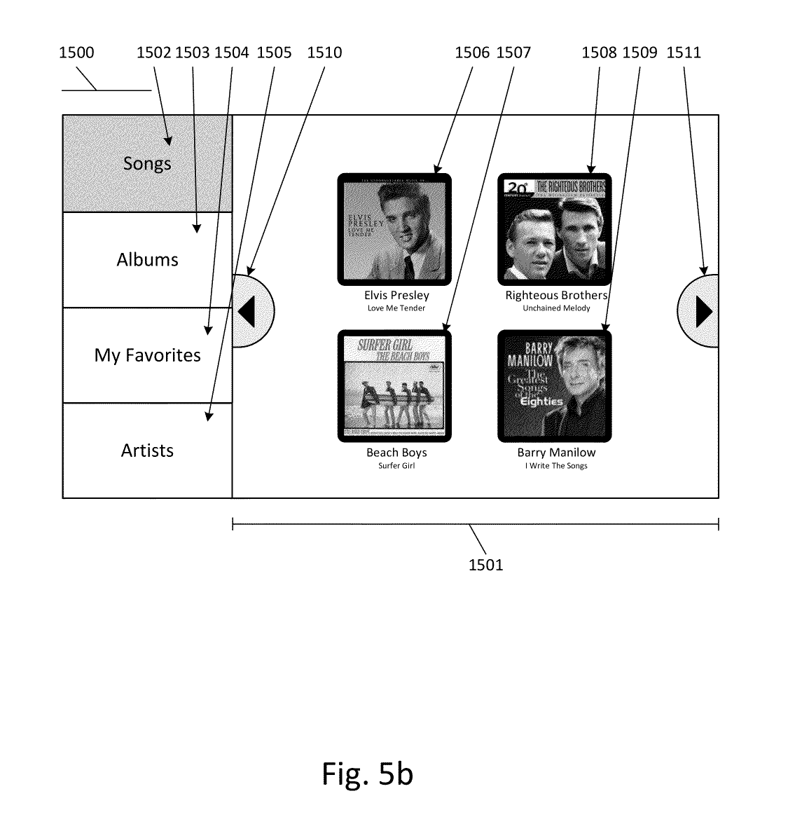

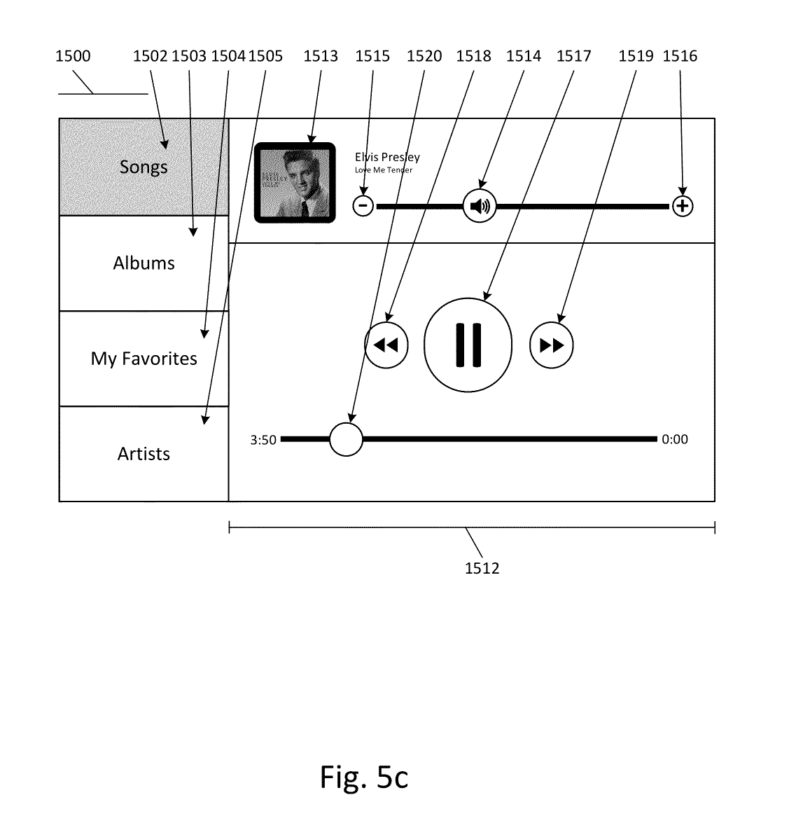

Referring now to FIGS. 1 and 5a through 5c, when the user touches media application browser soft button 1004, a media application browser program is activated. The media application browser program initially presents media application browser top level user interface 1400. Media application scroll box 1401 is comprised of at most eight touch screen active areas or soft buttons each of which launches a particular media application. In this exemplary embodiment, for example, a single row of soft buttons 1402 through 1405 launch the following media applications, respectively: 1) Soft button 1402 launches a music player application; 2) Soft button 1403 launches a Kindle® e-reader application; 3) Soft button 1404 launches a Netflix® streaming application; and, 4) Soft button 1405 launches a Skype® client. Delete application soft button 1406 and add application soft button 1407 are provided to allow the user to delete and add media applications to media application scroll box 1401. If more than eight media applications are available, the user may touch and swipe media application scroll box 1401 in a horizontal motion to scroll to additional media applications. Since such gestures are unfamiliar to, or difficult to execute for many seniors and visually impaired individuals, horizontal scrolling soft buttons 1408 and 1409 are provided.

A typical media application is launched and used as follows: When the user touches music application soft button 1402, a music player is activated. The music player initially presents music player top level user interface 1500. Music player top level user interface 1500 has four soft buttons 1502 through 1505 arrayed on one side used, respectively, to show: 1) The music player sub-level song view as shown in FIG. 5b; 2) The music player sub-level albums view; 3) The music player sub-level my favorites view; and, 4) The music player sub-level artists view. The music player program defaults to a state as if the user had touched songs soft button 1502 and automatically displays music player top level user interface 1500 preset to show the music player sub-level songs view as shown in FIG. 5b. Song list area 1501 is initially populated with a selection of four songs, e.g. 1506 through 1509. Each song in song list area 1501 presents, at a minimum, the artist, and the title of the song. Other song specific information, such as album art, may be optionally included. If more than page full of songs are available for play, the user may touch and swipe song list area 1501 in a horizontal motion to scroll to additional songs. Since such gestures are unfamiliar or difficult to execute for many seniors and visually impaired individuals, horizontal scrolling soft buttons 1510 and 1511 are provided. The surface area occupied by soft buttons 1502 through 1505 constitutes about at least 20% of music player top level user interface 1500 and no more than four soft buttons are present on music player top level user interface 1500. Also, the number of song records visible in song list area 1501 may never exceed six.

If the user touches an entry in song list area 1501 (e.g. song 1506) the music player sub-sub-level play view as shown in FIG. 5c is activated. Each song in player area 1512 includes, at a minimum, the artist and the title of the song. Other song specific information, such as album art 1513, is displayed if optionally included. The user plays and enjoys the selected song in the follow manner: The user touches play/pause soft button 1517 to begin playing the selected song. Subsequent alternate touches of play/pause soft button 1517, pauses and resumes play, respectively, of the selected song. Next the user adjusts the listening volume to a comfortable level by means volume slider soft control 1514 or separate decrease volume and increase volume soft buttons, 1515 and 1516, respectively. Skip back soft button 1518 and skip forward soft button 1519 can be used to rapidly advance backwards and forwards, respectively, as the selected song is played. Alternately, the user can touch and drag time slider soft control 1520 to select a particular passage in the selected song.

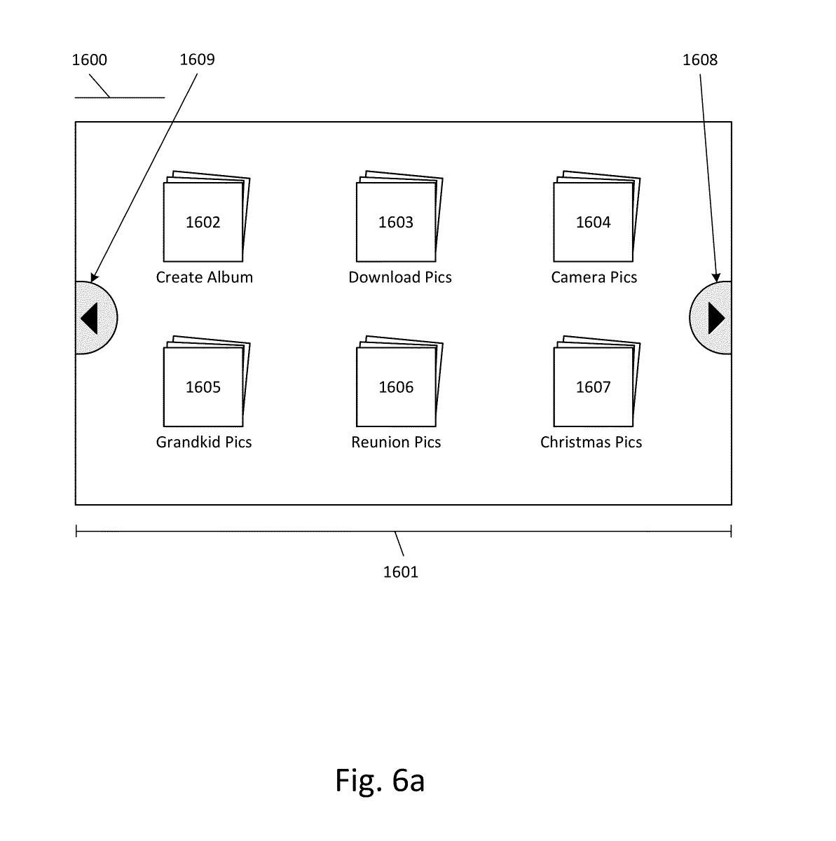

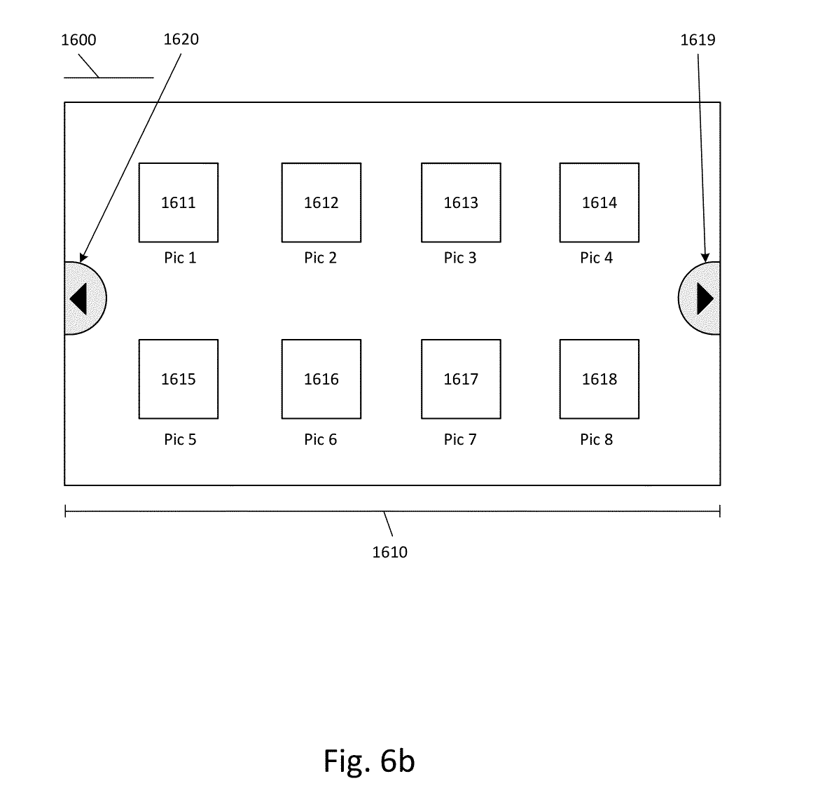

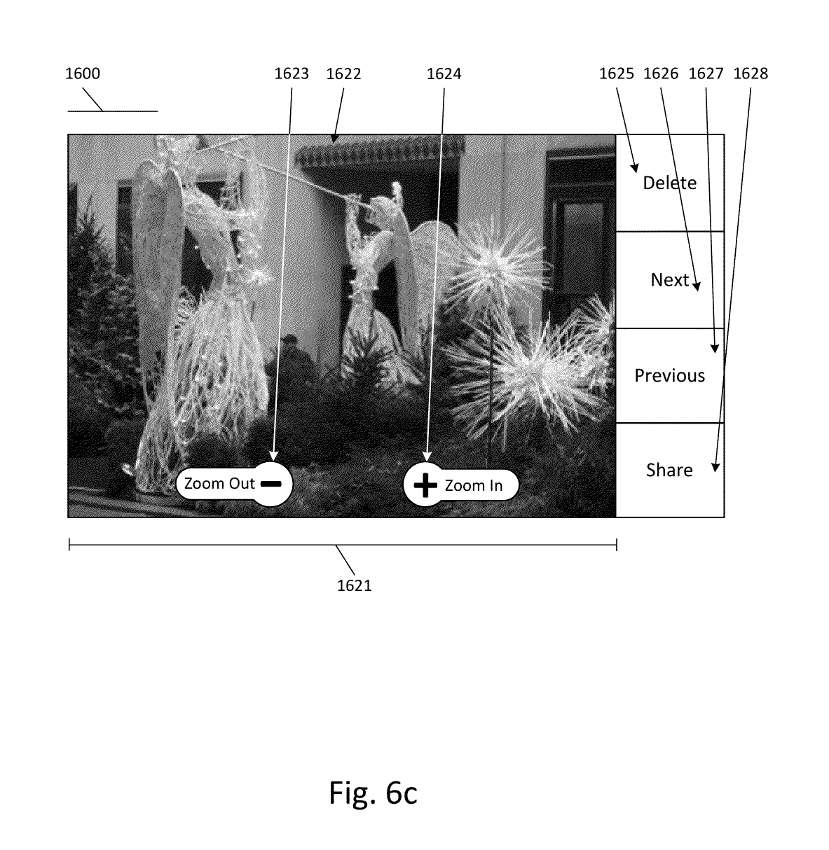

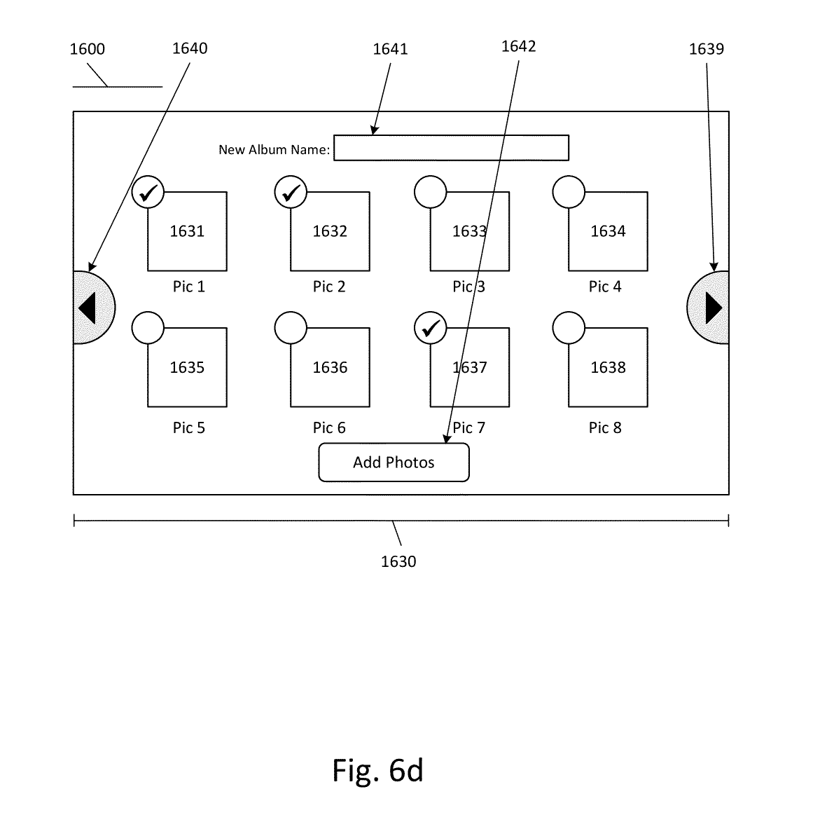

Referring now to FIGS. 1 and 6a through 6d, when the user touches pictures soft button 1005, a photo album browser program is activated. The photo album browser program initially presents photo album browser top level user interface 1600. Photo scroll box 1601 is comprised of at most six touch screen active areas or soft buttons which are used to create new photo albums and access previously created photo albums. In this exemplary embodiment, for example, a double row of soft buttons 1602 through 1607 perform the following functions, respectively: 1) Soft button 1602 creates a new photo album; 2) Soft button 1603 opens a default system photo album for downloaded pictures; 3) Soft button 1604 opens a default system photo album for still photos and movies captured using the camera program; and 4) Soft buttons 1605 through 1607 open custom photo albums entitled “Grandkid Pics,” “Reunion Pics,” and “Christmas Pics,” respectively. If more than six items are available via photo album scroll box 1601, the user may touch and swipe photo album scroll box 1601 in a horizontal motion to scroll to additional photo albums. Since such gestures are unfamiliar or difficult to execute for many seniors and visually impaired individuals, horizontal scrolling soft buttons 1608 and 1609 are provided.

If the user touches an entry in photo album scroll box 1601 (e.g. photo album 1607) the photo bowser sub-level album view as shown in FIG. 6b is activated. Each photo in photo scroll box 1610 (e.g. photos 1611 through 1618) includes, at a minimum, a thumbnail of the photo. Other photo specific information is displayed if optionally included. If more than eight photos are available via photo scroll box 1610, the user may touch and swipe photo scroll box 1610 in a horizontal motion to scroll to additional photos. Since such gestures are unfamiliar or difficult to execute for many seniors and visually impaired individuals, horizontal scrolling soft buttons 1619 and 1620 are provided.

If the user touches a photo in photo scroll box 1601 (e.g. photo 1611) the photo browser sub-sub-level photo view as shown in FIG. 6c is activated and selected photo 1622 fills photo viewer box 1621. The user reviews and enjoys selected photo 1622 and the other photos in the selected album song in the follow manner: The user reviews selected photo 1622 and may zoom out or in, respectively, using zoom out soft button 1623 or zoom in soft button 1624, respectively. To delete selected photo 1622, the user touches delete soft button 1625. To share selected photo 1622 via social media applications, the user touches share soft button 1628. Finally, when done reviewing selected photo 1622, the user may select another photo by touching and swiping photo viewer box 1621 in a horizontal motion to scroll to additional photos. Since such gestures are unfamiliar or difficult to execute for many seniors and visually impaired individuals, next soft button and previous soft buttons, 1626 and 1627, respectively perform analogous functions.

If the user touches create album soft button 1602 in photo album scroll box 1601 the photo bowser sub-level create album view as shown in FIG. 6d is activated and all unclassified photos (i.e. photos in the system default camera and download albums) fill unclassified photo scroll box 1630 (e.g. photos 1631 through 1638). Each photo includes, at a minimum, a thumbnail of the photo. Other photo specific information is displayed if optionally included. Each photo has a check box soft button designator allowing the user to select the photo (e.g. photos 1631, 1632, and 1637) for inclusion in a new album. If more than eight photos are available via unclassified photo scroll box 1630, the user may touch and swipe unclassified photo scroll box 1630 in a horizontal motion to scroll to additional photos. Since such gestures are unfamiliar or difficult to execute for many seniors and visually impaired individuals, horizontal scrolling soft buttons 1639 and 1640 are provided. After selecting the desired photos, the user provides a name for the new photo album via new album name field 1641 and touches add photos soft button 1642 to place the selected photos in the new album.

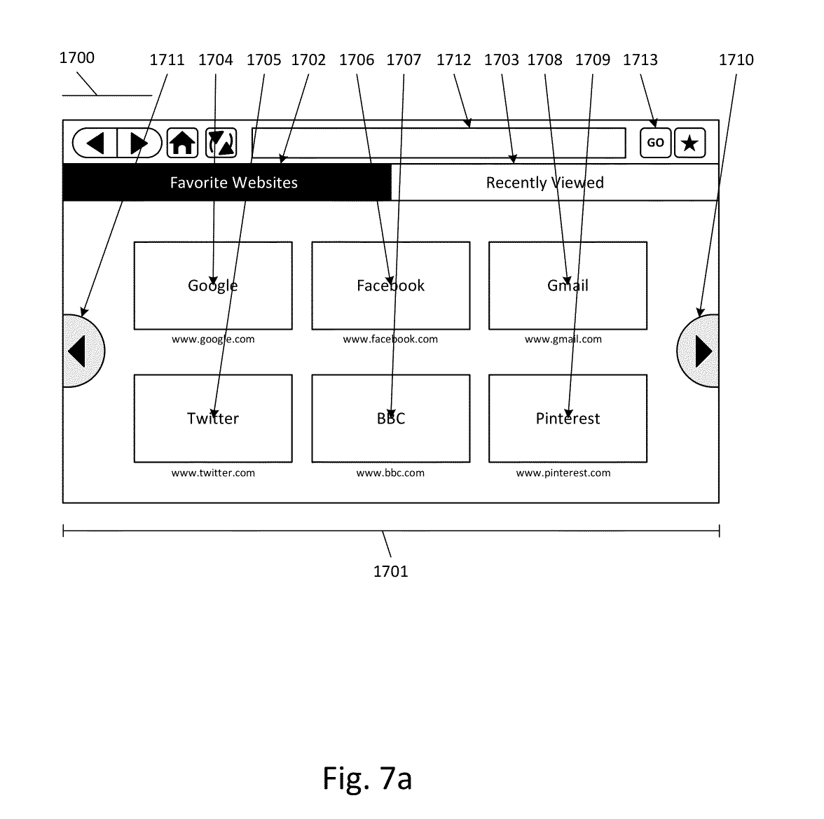

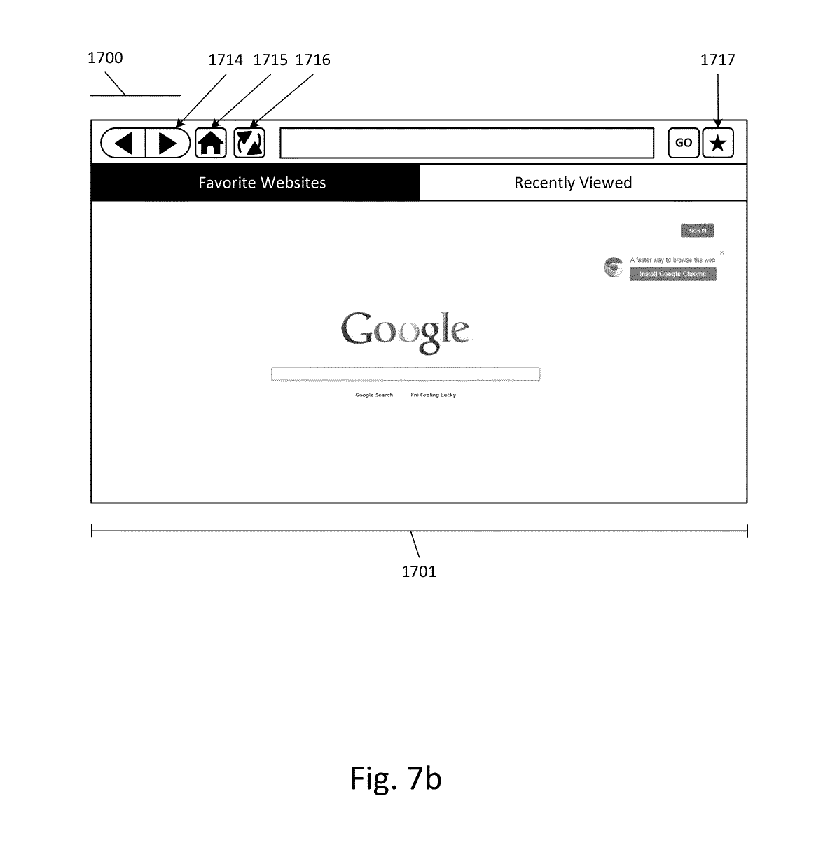

Referring now to FIGS. 1, 7a, and 7b, when the user touches Internet soft button 1006, an Internet browser program is activated. The Internet browser program initially presents Internet browser top level user interface 1700. Browser window 1701 is comprised initially of at most six touch screen active areas or soft buttons, 1704 through 1709, respectively. This group of soft buttons is designated as the user's favorite websites and is accessible by means of favorite websites tab soft button 1702. Recently viewed tab soft button 1703 provides a similar group of recently viewed websites. If more than six websites are available via browser window 1701 when favorite websites tab soft button is actuated, the user may touch and swipe browser window 1701 in a horizontal motion to scroll to additional favorite websites. Since such gestures are unfamiliar or difficult to execute for many seniors and visually impaired individuals, horizontal scrolling soft buttons 1710 and 1711 are provided. Alternately, the user may directly provide the URL of the desired website via URL field 1712 and touch go soft button 1713 to load the desired website.

If the user touches a website accessible via favorite websites tab soft button 1702 (e.g. Google® website soft button 1704), touches a website soft button accessible via recently viewed websites tab soft button 1703, or directly enters the URL of the desired website via URL field 1712 and touches go soft button 1713 to load the desired website, browser window 1701 subsequently displays the desired website. Here, the user may touch horizontal scrolling soft button 1714 to navigate to hierarchically higher, or hierarchically lower, websites in a chain of hot-linked websites. The left half of horizontal scrolling soft button 1714 loads the hierarchically higher website, if any, while the right loads the hierarchically lower website, if any. Home soft button 1715 returns to the user's designated home website while reload soft button 1716 reloads the current webpage to view any recent updates. Finally the user self designates a particular website as a favorite website by touching star soft button 1717. Subsequently, the newly self-designated favorite website will appear when favorite websites tab soft button 1702 is touched.

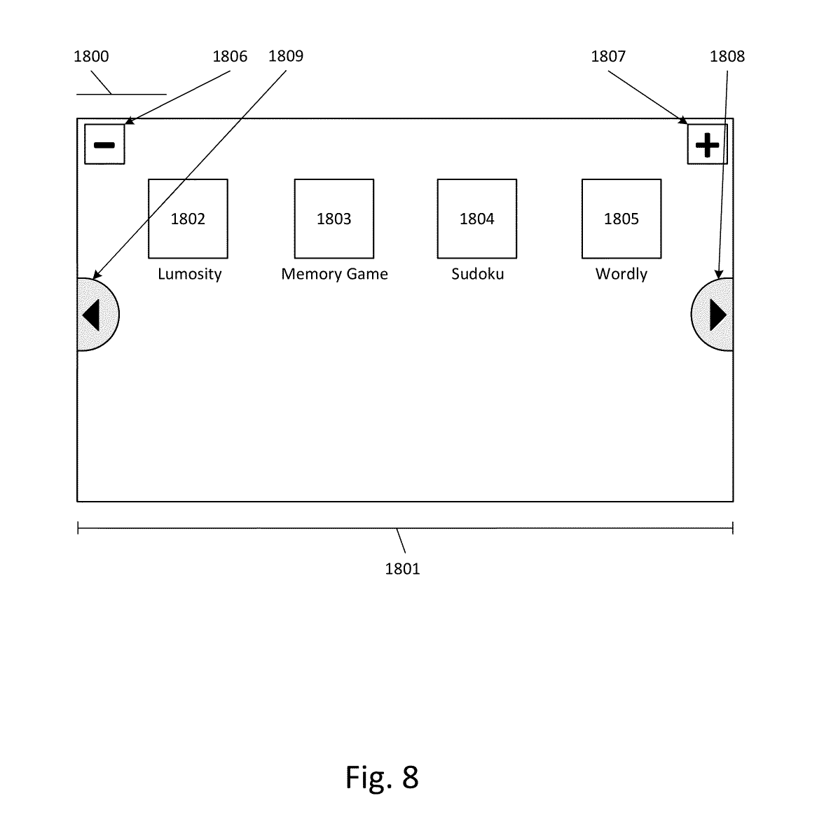

Referring now to FIGS. 1 and 8, when the user touches game application browser soft button 1007, a game application browser program is activated. The game application browser program initially presents game application browser top level user interface 1800. Game application scroll box 1801 is comprised of at most eight touch screen active areas or soft buttons each of which launches a particular game application. In this exemplary embodiment a single row of soft buttons 1802 through 1805 launch the following game applications, respectively: 1) Soft button 1802 launches a Lumosity® game; 2) Soft button 1803 launches a memory game; 3) Soft button 1804 launches a Sodoku game; and, 4) Soft button 1405 launches a Wordly® game. Delete game application soft button 1806 and add game application soft button 1807 are provided to allow the user to delete and add game applications to game application scroll box 1801, respectively. If more than eight game applications are available, the user may touch and swipe game application scroll box 1801 in a horizontal motion to scroll to additional game applications. Since such gestures are unfamiliar or difficult to execute for many seniors and visually impaired individuals, horizontal scrolling soft buttons 1808 and 1809 are provided.

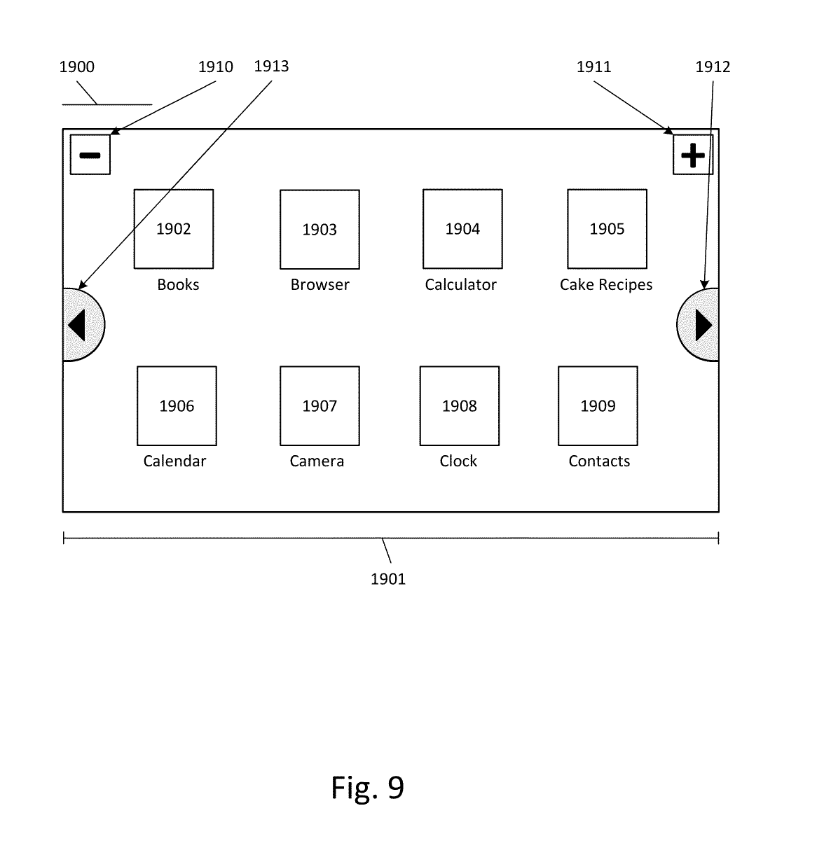

Referring now to FIGS. 1 and 9, when the user touches application browser soft button 1008, an application browser program is activated. The game application browser program initially presents application browser top level user interface 1900. Application scroll box 1901 is comprised of at most eight touch screen active areas or soft buttons each of which launches a particular application. In this exemplary embodiment a double row of soft buttons 1902 through 1909 launch the following game applications, respectively: 1) Soft button 1902 launches an e-reader app; 2) Soft button 1903 launches the web browser; 3) Soft button 1904 launches a calculator app; 4) Soft button 1905 launches a cake recipes app; 5) Soft button 1906 launches a calendar app; 6) Soft button 1907 launches the camera app; 7) Soft button 1908 launches a clock app; 8) Soft button 1909 launches a contacts app. Delete application soft button 1910 and add application soft button 1911 are provided to allow the user to delete and add applications to application scroll box 1901, respectively. If more than eight applications are available, the user may touch and swipe application scroll box 1901 in a horizontal motion to scroll to additional applications. Since such gestures are unfamiliar or difficult to execute for many seniors and visually impaired individuals, horizontal scrolling soft buttons 1912 and 1913 are provided.

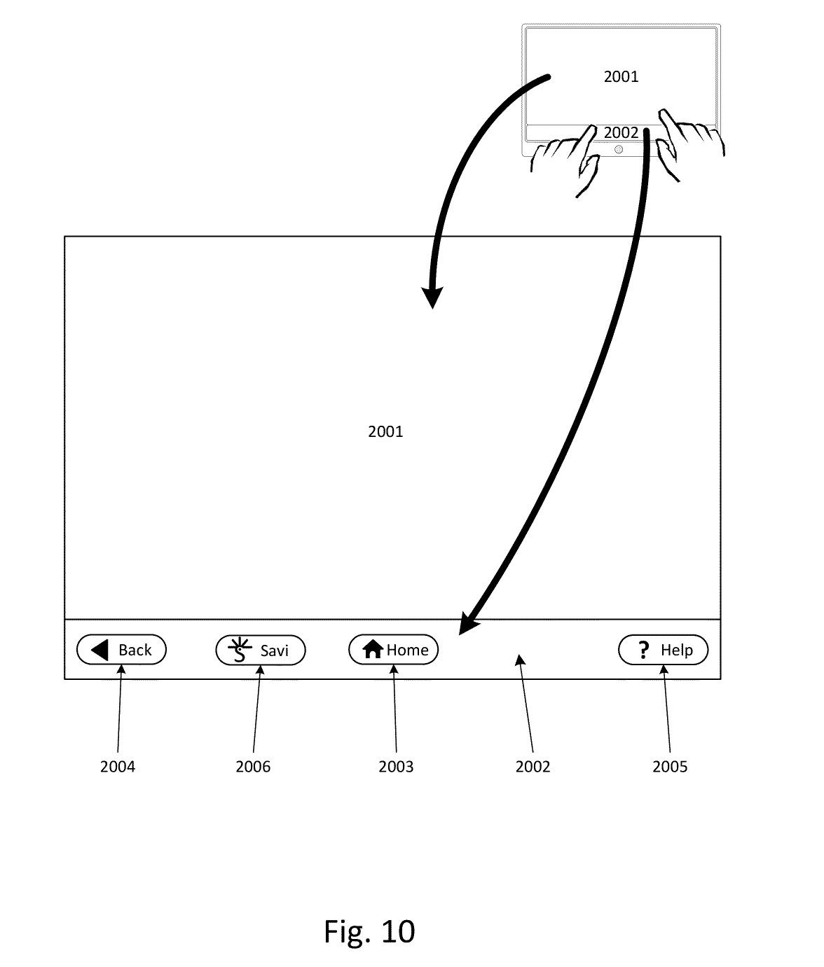

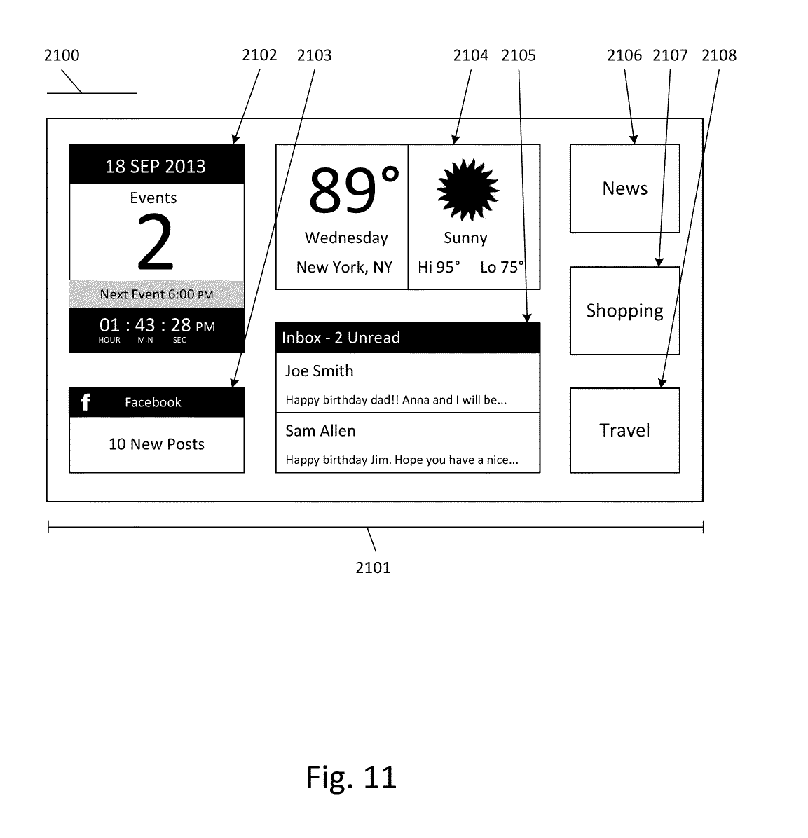

Referring now to FIGS. 1, 10, and 11 all top level program interfaces appear in zone 2001 of the display of tablet computer 2000. Simultaneously, a task bar appears in zone 2002 of the display. While all top level program interfaces and their sub-level and sub-sub-level child interfaces appear in zone 2001, various static, universally accessible soft buttons appear in the task bar in zone 2002. These remain substantially constant and fixed during the operation of tablet computer 2000. The first is home screen soft button 2003. When the user touches home screen soft button 2003, home screen 1000 appears in zone 2001 on the display of tablet computer 2000. Next, is back soft button 2004. When the user touches back soft button 2004, the sub-level or sub-sub-level interface displayed in zone 2001 reverts to the interface displayed previously, even if the interfaced displayed previously was generated by a different application. When the user has retraced a chain of interfaces and reached home screen 1000 in zone 2001, back soft button 2004 does nothing. For example, if calendar sub-level add appointment view as shown on FIG. 3c is displayed in zone 2001, touching back soft button 2004 one time causes the calendar program to revert to calendar top level user interface as shown in FIG. 3a in zone 2001. Touching back soft button 2004 one more time causes the system to revert to home screen 1000 in zone 2001. Subsequent presses of back soft button 2004 do nothing. When the user touches help soft button 2005, a help screen contextually tailored to the user's present activities is displayed. For example, if calendar sub-level add appointment view as shown on FIG. 3c is displayed in zone 2001, touching help soft button 2005 causes a help screen directed at assisting the user with the process of adding a new appointment to the calendar, and so on.

When the user touches Savi™ screen soft button 2006, Savi screen top level user interface 2100 appears in zone 2001. Within this, status dashboard area 2101 contains notifications of important information and links to specific websites or applications tailored to the particular user. In this exemplary embodiment, calendar status block 2102 shows essential calendar status including, but not limited to, the date, the time, the number of events pending that day, the time of the next event and so on. Facebook® status block 2103 shows essential Facebook status including, but not limited to, the number of unread posts. Weather status block 2014 shows essential weather and forecast information including, but not limited to, the temperature, current outlook, and expected high and low temperatures. Email status block 2105 shows essential email status including, but not limited to, the first two unread email messages, from whom they were received, and the first few words of each respective email message. If the user touches a particular status indicator 2102 through 2105, the system displays the appropriate top-level, sub-level, or sub-sub-level interface of the appropriate application where the user can more fully review status. For example, if the user touches email status block 2105, the system launches the email application showing the user's email inbox as shown in FIG. 2a. Similarly, if the user touches calendar status block 2102, the system launches the calendar application showing the user's calendar as presented in FIG. 3a, and so on. Link blocks 2106 through 2108 represent links to a number of the user's selected favorite applications or webpages. For example, link block 2106 might launch a favorite news app (e.g. the Wall Street Journal Android App) or a favorite news webpage (e.g. www.bbc.com). Similarly, link block 2107 may launch a favorite shopping app (e.g. the eBay Android App) or a favorite shopping page (e.g. www.amazon.com), and so on.

What is claimed is:

1. A method of implementing a user interface on a tablet computer, including memory, comprising:
a. Storing in said memory a first set of information corresponding to a home screen;
b. Storing in said memory a second set of information corresponding to email application pages associated with an email application;
c. Storing in said memory a third set of information corresponding to calendar application pages associated with a calendar application;
d. Storing in said memory a fourth set of information corresponding to camera application pages associated with a camera application;
e. Storing in said memory a fifth set of information corresponding to media application browser application pages associated with a media application browser application;
f. Storing in said memory a sixth set of information corresponding to photo viewer application pages associated with a photo viewer application;
g. Storing in said memory a seventh set of information corresponding to web browser application pages associated with a web browser application;
h. Storing in said memory an eighth set of information corresponding to game application browser application pages associated with a game browser application;
i. Storing in said memory a ninth set of information corresponding to application browser application pages associated with an application browser application;
j. Storing in said memory a tenth set of information corresponding to a task bar;
k. Storing in said memory an eleventh set of information corresponding to a status dashboard page;
l. Presenting said task bar to the user, the user being presented with at least two soft buttons, the first of which selects said status dashboard and the second of which selects said home screen;
m. Presenting said home screen to the user, such that said task bar remains visible, said home screen presenting to said user at most eight soft buttons covering in total at least about 20% of the surface are of said home screen, each soft button selecting a particular set of application pages associated with a particular application;
n. Presenting said top level application page of an application selected from said home screen, the user being presented with at least one soft button covering in total at least about 20% of the total surface area of said top level application page, each soft button selecting a sub-level application page of the selected application;
o. Presenting said sub-level application page of the selected application selected from said top level application page, the user being presented with at least one soft button covering in total at least about 20% of the total surface area of said sub-level application page, each soft button selecting a sub-sub-level application page;
p. Repeating steps m through o a plurality of times.
